(19) United States
(12) Patent Application Publication
(10) Pub. No.: US 2004/0114290 A1
(43) Pub. Date: Jun. 17, 2004

(54) Low impedance transmission line with a power flow controller

(76) Inventor: Arnold P. Kehrli, Middleton, WI (US)

Correspondence Address: FISH & RICHARDSON PC, 225 FRANKLIN ST, BOSTON, MA, 02110, US

(21) Appl. No.: 10/658,597

(22) Filed: Sep. 9, 2003

Related U.S. Application Data
(60) Provisional application No. 60/409,286, filed on Sep. 9, 2002.

(51) Int. Cl. H02J 3/06

(52) U.S. Cl. 361/84; 307/20

(57) ABSTRACT

A multi-line power transmission system includes a first power transmission line having a first impedance characteristic, a second power transmission line, in parallel with the first power transmission line, and having a second impedance characteristic less than the first impedance characteristic, and a power flow controller, coupled to the second power transmission line, for controlling at least one of the magnitude and direction of the power flowing through the second power transmission line.

This application claims the benefit of U.S. Provisional Application No. 60/409,286, filed Sep. 9, 2002, which is incorporated herein by reference.

### TECHNICAL FIELD

This invention relates to power flow regulation for utility power systems.

### BACKGROUND

Transmission lines are used to transfer electrical power from one point in a utility network to another (e.g., from a power station to a substation). Transmission lines have associated electrical impedance, which is typically expressed in ohms. The higher the impedance of the transmission line, the greater the amount of real and reactive power dissipated along the length of the line. Therefore, as the impedance of the transmission line decreases, the efficiency of the transmission line and the ability to transfer energy increases.

### SUMMARY

In one aspect of the invention, a multi-line power transmission system includes a first power transmission line having a first impedance characteristic, a second power transmission line, in parallel with the first power transmission line, and having a second impedance characteristic less than the first impedance characteristic, and a power flow controller, coupled to the second power transmission line, for controlling at least one of the magnitude and direction of the power flowing through the second power transmission line.

Embodiments of the invention may include one or more of the following features. The second power transmission line includes a superconductor, for example, a high temperature superconductor. The superconductor is constructed of a low-impedance cold dielectric high temperature superconducting cable, that uses conductors constructed of a high temperature superconductor, such as: thallium-barium-calcium-copper-oxide; bismuth-strontium-calcium-copper-oxide; mercury-barium-calcium-copper-oxide; yttrium-barium-copper-oxide; or magnesium-borides.

A refrigeration system maintains the cold dielectric high temperature superconducting cable at an operating temperature that is low enough to enable the cold dielectric high temperature superconducting cable to exhibit superconducting characteristics.

The power flow controller may be a reactor. Further, a bi-directional power flow controller, such as a phase angle regulator, may be used to regulate the direction of the power transferred through the cold dielectric high temperature superconducting cable. Multiple reactors or multiple phase angle regulators may be used and connected in various configurations, such as parallel and series. By varying the number and configuration of these devices, the level of reactance and/or phase angle change can be adjusted, thus adjusting the level of regulation of the power flow and direction.

The multi-line system may include one or more non-superconducting power transmission lines as well as one or more superconducting power transmission lines.

According to a further aspect of this invention, a method includes the following steps. A first power transmission line having a first impedance characteristic is connected to a second power transmission line having a second impedance characteristic less than the first impedance characteristic. Power is supplied to the first and second power transmission lines. A level of power flow for the second power transmission line is determined. The amount of power transferred through the second power transmission line is regulated.

This aspect of the invention may include one or more of the following features. The direction of the power transferred through the superconducting power transmission line is also regulated. The second power transmission line includes a superconductor, for example, a high temperature superconductor.

The operating temperature of the cold dielectric high temperature superconductor is maintained at a level that is low enough to enable the cold dielectric high temperature superconducting cable to exhibit superconducting characteristics.

The non-superconducting power transmission line may be a conventional overhead transmission line or an underground cable (such as a cross-linked polyethylene power transmission cable).

One or more of the following advantages are provided from the above aspects of the invention. Power can be transferred more efficiently between locations, resulting in reduced power losses and decreased voltage drops. The lower reactive losses associated with high temperature superconductor systems also reduces the need for reactive compensation and allows for a more uniform voltage profile across the system. The use of a superconducting transmission line, such as one incorporating cold dielectric, high temperature superconductors, further enhances efficiency. By using a power flow controller, such as a reactor and/or a phase angle regulator, the amount and direction of real power passing through superconducting transmission line can be regulated. This regulation further allows the transmission line to be incorporated into power grids or systems incorporating traditional transmission lines, such as conventional overhead transmission lines or underground cables (e.g., cross-linked polyethylene power transmission cable). Further, due to a superconducting transmission line's low impedance, less expensive phase angle regulators can be used to provide the same level of current regulation (when compared to non-superconducting transmission lines).

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatic view of a power transmission system using conventional transmission lines;

FIG. 2 is a schematic representation of a transmission line;

FIG. 2A is a vector diagram showing the angular relationship between the sending and receiving voltages;

FIG. 3 is a diagrammatic view of a power transmission system using superconducting transmission line; and

FIG. 4 is a flow chart of a multi-line power transmission method.

Like reference symbols in the various drawings indicate like elements.

### DETAILED DESCRIPTION

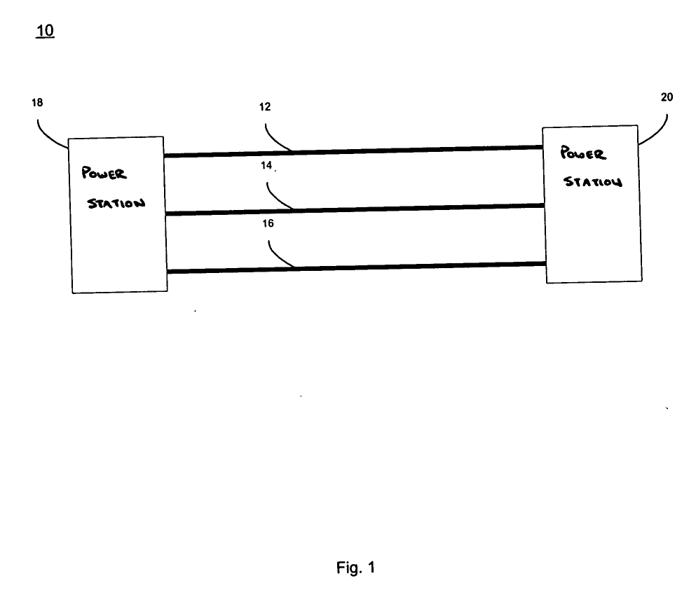

Referring to FIG. 1, a power transmission system 10 is shown to include multiple power transmission lines 12, 14, 16 for transferring electrical power between a first power station 18 and a second power station 20, typically separated by many miles. Power stations 18, 20 can also be generation plants or power substations.

Power transmission lines typically transfer power at high voltages between 115,000 volts and 765,000 volts. These high voltages are stepped down to lower voltages (e.g., 69,000 to 138,000 volts) by substations, and may subsequently be stepped down again by distribution stations (not shown) prior to being distributed to customers. These values are typical and vary depending on application and locality.

Each transmission line 12, 14, 16 has an impedance value (Z) representing the impedance per unit length, typically ohms. To reduce losses and increase efficiency, these impedances should be minimized. When power is transferred through transmission lines 12, 14, 16, the flow of power is divided among the three lines, such that the level of power flowing through each line is inversely proportional to its impedance. Therefore, if lines 12, 14, 16 have impedances of 2 ohms, 4 ohms, and 6 ohms respectively, and 300 megawatts is being distributed to the transmission lines, the power flow would be distributed as follows:

| Transmission | | | |
|---|---|---|---|
| Line | Impedance | Portion of Flow | Flow (in megawatts) |
| Line 12 | 2 ohms | (2+4+6)/2 → 54.55% | 163.65 Megawatts |
| Line 14 | 4 ohms | (2+4+6)/4 → 27.27% | 81.81 Megawatts |
| Line 16 | 6 ohms | (2+4+6)/6 → 18.18% | 54.54 Megawatts |

Because the impedance of transmission line 12 is half that of transmission line 14, twice as much power is transferred through transmission line 12. Transmission lines 12, 14, 16 have impedance values in the range of 2 ohms to 6 ohms, which are considered to be within the normal range for 69 kV, 115 kV, and 138 kV overhead transmission lines.

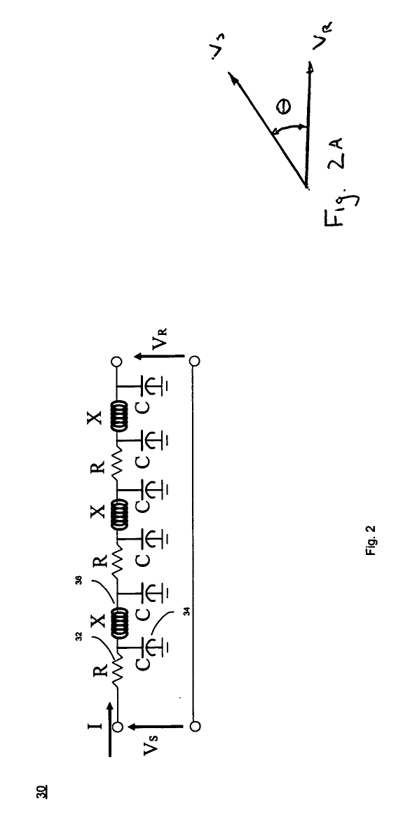

Referring to FIG. 2, a schematic model 30 of a transmission line is shown. A transmission line can be modeled as a series of resistors (e.g., resistor 32), capacitors (e.g., capacitor 34), and inductors (e.g., inductor 36). The impedance of the transmission line is calculated using the following general formula:

Z=\sqrt{R²+X²}

Z is the impedance of a high voltage transmission line (in ohms), R is the resistance of the transmission line (in ohms), and X is the inductive reactance of the line (in ohms). As the capacitance C is a shunt to ground, the effect that the capacitance of the transmission line has on the impedance of a transmission line is negligible and, therefore, is not a factor of the formula. Since the inductive reactance of the transmission line is typically six to twenty times greater than the resistance of the transmission line, the impedance (Z) of high voltage transmission lines is essentially equal to the inductive reactance (X) of the line.

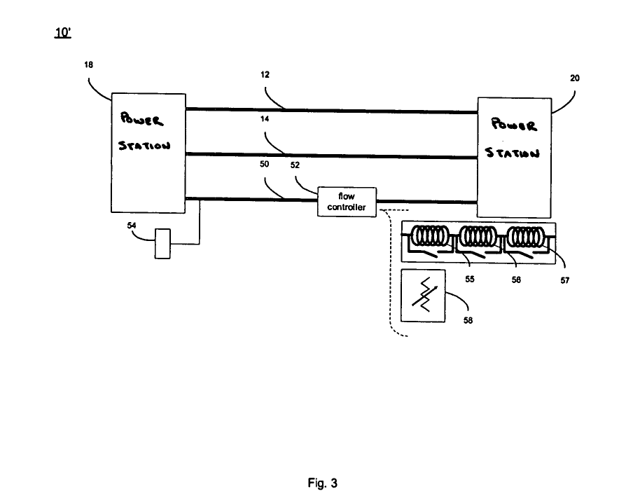

Referring to FIG. 3, power transmission system 10′ is shown with one of the three transmissions line replaced with a superconducting transmission line 50 and a power flow controller 52 (to be discussed below). Typically, a low impedance multi-mile high temperature superconductor (HTS) transmission line has an impedance that is about 1/20th that of an overhead transmission line of the same length and voltage or, in this case, approximately 0.10 ohms.

Superconducting transmission line 50 is constructed using a low impedance, cold dielectric high temperature superconducting cable. This cold dielectric HTS cable uses conductors formed from: thallium-barium-calcium-copper-oxide; bismuth-strontium-calcium-copper-oxide; mercury-barium-calcium-copper-oxide; yttrium-barium-copper-oxide, and magnesium borides. A superconducting transmission line has an impedance that is typically six to twenty times less than a conventional (i.e., non-superconducting) underground cable or overhead transmission line, respectively. HTS power transmission cables, including cold dielectric cables, have been and are continuing to be demonstrated by the following companies: Pirelli Cavi e Sistemi Energia S.p.A., Sumitomo Electric Industries, and Southwire Company.

As these low dielectric HTS cables only achieve their superconducting characteristics when operating at low temperatures, power transmission system 10′ typically includes a refrigeration system 54. Refrigeration system 54 is typically a cryogenic cooler that maintains the operating temperature of low impedance transmission line 50 at an operating temperature low enough to allow the low impedance HTS conductors to exhibit their superconducting characteristics.

The resistance (R) and reactance (X) of an HTS transmission line is a factor of about 300 and 6, respectively, less than the resistance and reactance of a conventional non-superconducting underground transmission cable rated at the same voltage. Moreover, the resistance (R) and reactance (X) of an HTS transmission line is a factor of about 800 and 20, respectively, less than the resistance and reactance of a conventional overhead transmission line rated at the same voltage. The lower impedance of the superconducting transmission line reduces VAR losses and the voltage drop between the source and load, which reduces the need for reactive compensation and provides a more uniform voltage profile across the network.

Another advantage of using superconductor transmission lines is that the effective electrical distance between a generator and load. This reduces the potential for angular and voltage instability problems. For example, if twenty miles separate a source and load, the relatively low impedance of an HTS power transmission line reduces the effective electrical separation from twenty miles to one mile. This reduction is due to the 20:1 ratios of impedances overhead transmission lines and HTS transmission lines as was mentioned earlier. This reduction in the effective electrical separation is advantageous in siting electrical generators away from, for example, metropolitan areas.

The decrease in reactance (X) is relatively more important than the decrease in resistance because it is the reactance that determines the proportion of flow along each parallel transmission line.

For example, continuing with the above-stated example, if 300 megawatts of power were being distributed between power stations 18 and 20, and transmission line 12 has an impedance of 2 ohms, transmission line 14 has an impedance of 4 ohms, and cold dielectric superconducting cable 50 has an impedance of 0.1 ohms, the power flow would be distributed as follows:

| Trans- | | | |
|---|---|---|---|
| mission | | | |
| Line | Impedance | Portion of Flow | Flow (in megawatts) |
| Line 12 | 2 ohms | (2+4+0.1)/2 → 4.650% | 13.94 Megawatts |
| Line 14 | 4 ohms | (2+4+0.1)/4 → 2.325% | 6.97 Megawatts |
| Line 50 | 0.1 ohms | (2+4+0.1)/0.1 → 93.025% | 279.09 Megawatts |

The use of superconducting transmission lines allows for the off-loading or transfer of current loads from non-superconducting transmission lines. For various reasons (e.g., load balancing, contractual arrangements, flow optimization, etc.) it may be desirable to restrict and/or regulate the amount of current that is allowed to pass through superconducting transmission line 50. Accordingly, a power flow controller 52 is coupled to the superconducting transmission line 50 to control the impedance or the phase angle (and, therefore, real power) through the superconducting transmission line.

As shown in the above table, the replacement of a “non-superconducting” transmission line with a superconducting transmission line results in approximately ninety-three percent of all the transmitted power being transferred over superconducting transmission line 50. This translates to approximately two-hundred-seventy-nine of the three hundred megawatts being transferred over superconducting transmission line 50.

Power flow controller 52 can be one or more reactor 55, 56, 57. Reactors are devices that limit the amount of current that can flow on a line (i.e., superconducting transmission line 50) by adding their own impedance to the line's normal impedance. By activating or deactivating one or more of these reactors 55, 56, 57, the desired impedance characteristic (i.e., power flow control) can be achieved. Reactors are available from various suppliers, such as Trench Limited of Scarborough, Ontario, Canada.

Power flow controller 52 may also be bi-directional; that is it also controls the direction that the current (and, therefore, the power) flows through the transmission line. If bi-directional control or finer incremental flow change is desired, a phase angle regulator 58 can be coupled with the superconducting line 50.

Phase angle regulators (also referred to as power angle regulators or phase shifters) introduce a circulating power flow that travels through the regulated transmission line and returns through all the lines that are more or less in parallel with the regulated transmission line. With reference to FIGS. 2 and 2A, by varying this circulating power flow, phase angle regulator 58 varies the phase angle (θ) between the sending end voltage (Vₛ), e.g., voltage at location 18, and the receiving end voltage (Vᵣ), e.g., voltage at location 20. This, in turn, controls the magnitude and direction of the power flow (P) through the superconducting transmission line 50 in accordance with the following formula: Where (theta) is the angle difference between the sending and receiving end voltages.

$$P = \frac{( {V}_{s} ) ( {V}_{r} ) ( sin θ )}{Z}$$

where θ is the angle difference between the sending voltage (V_{S}) and the receiving voltage (V_{R}) (See FIG. 2A).

As shown in the above formula, the power flow (P) can be changed as the value of impedance (Z) changes. Since superconducting transmission line 50 has a very low impedance (Z), the sensitivity of the above formula is increased due to the very low impedance (Z) being in the denominator. By varying the phase angle (θ) between the sending end voltage (Vₛ) and the receiving end voltage (Vᵣ), the amount and direction of the current flow (i.e., power flow P) can be adjusted. Further, as the impedance (Z) of a superconducting transmission line is very low, for any fixed variation of the phase angle (θ), a greater variation of power flow (P) can be achieved (when compared to a non-superconducting transmission line). Phase angle regulators are manufactured by a number of suppliers, such as Siemens AG of Nuremburg, Germany.

While the power transmission system 10′ is described above as using either a single reactor 56 or a phase angle regulator 58, other arrangements are possible. For example, multiple reactors or multiple phase angle regulators may be used and connected in various configurations, such as parallel and series. By varying the number and configuration of these devices, the level of reactance and/or phase angle change can be adjusted, thus adjusting the level of regulation of the power flow and direction.

While the system is described above as using cold dielectric high temperature superconducting cable, other configurations are possible, such as warm dielectric high temperature superconducting cable.

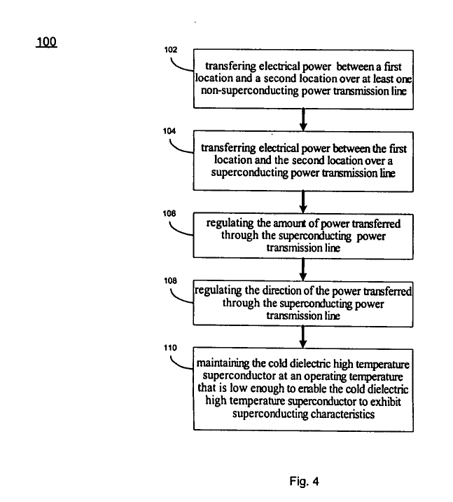

Referring to FIG. 4, a multi-line power transmission method 100 includes transferring 102 electrical power between spaced locations over at least one standard-impedance power transmission line. A low-impedance power transmission line transfers 104 electrical power between the locations. The amount of power transferred through the low-impedance power transmission line is regulated 106.

The direction of the power transferred through the low-impedance power transmission line is also regulated 108. The low-impedance power transmission line is a superconducting power transmission line, such as a cold dielectric high temperature superconducting cable.

The operating temperature of the cold dielectric high temperature superconducting cable is maintained 110 at a level that is low enough to enable the cold dielectric high temperature superconducting cable to exhibit superconducting characteristics.

The at least one standard-impedance power transmission line is a conventional overhead transmission line or an underground power transmission cable.

A number of embodiments of the invention have been described. Nevertheless, it will be understood that various modifications may be made without departing from the spirit and scope of the invention.

1. A multi-line utility power transmission system comprising:
a first power transmission line having a first impedance characteristic;
a second power transmission line, in parallel with the first power transmission line, and having a second impedance characteristic less than the first impedance characteristic; and
a power flow controller, coupled to the second power transmission line, for controlling at least one of the magnitude and direction of the power flowing through the second power transmission line.

2. The multi-line power transmission system of claim 1 wherein the second power transmission line includes a superconductor.

3. The multi-line power transmission system of claim 2 wherein the superconductor is a high temperature superconductor.

4. The multi-line power transmission system of claim 3 wherein the high temperature superconductor is chosen from the group consisting of: thallium-barium-calcium-copper-oxide; bismuth-strontium-calcium-copper-oxide; mercury-barium-calcium-copper-oxide; and yttrium-barium-copper-oxide.

5. The multi-line power transmission system of claim 3 further comprising a refrigeration system for cooling the high temperature superconductor at a temperature sufficiently low to exhibit superconducting characteristics.

6. The multi-line power transmission system of claim 1 wherein the first power transmission line is a cross-linked polyethylene power transmission line.

7. The multi-line power transmission system of claim 7 wherein the power flow controller is a reactor.

8. The multi-line power transmission system of claim 1 wherein the power flow controller is a bi-directional power flow controller that regulates the direction of the power transferred through the second power transmission line.

9. The multi-line power transmission system of claim 8 wherein the bi-directional power flow controller is a phase angle regulator.

10. A method comprising:
connecting a first power transmission line having a first impedance characteristic in parallel with a second power transmission line having a second impedance characteristic less than the first impedance characteristic;
supplying power to the first power transmission line and the second power transmission line;
determining a level of power flow for the second power transmission line; and
regulating the amount of power transferred through the second power transmission line.

11. The method of claim 10 further comprising regulating the direction of the power transferred through the second power transmission line.

12. The method of claim 10 further comprising forming the second power transmission line with a superconductor.

13. The method of claim 12 wherein the superconducting power transmission line is a high temperature superconductor.

14. The method of claim 10 further comprising maintaining the high temperature superconductor at an operating temperature sufficiently low to enable the high temperature superconductor to exhibit superconducting characteristics.

15. The method of claim 10 further comprising forming the first power transmission line with a cross-linked polyethylene.
